(19) United States
(12) Patent Application Publication
(10) Pub. No.: US 2002/0005229 A1
(43) Pub. Date: Jan. 17, 2002

(54) Wood product having a composite substrate covered with paper

(76) Inventor: Stanley C. Johnson, Brookings, OR (US)

Correspondence Address: MARGER JOHNSON & McCOLLOM, P.C., 1030 S.W. Morrison Street, Portland, OR, 97205, US

(21) Appl. No.: 09/903,795

(22) Filed: Jul. 11, 2001

Related U.S. Application Data
(60) Provisional application No. 60/217,748, filed on Jul. 12, 2000.

(51) Int. Cl. B27D 1/00

(52) U.S. Cl. 144/346

(57) ABSTRACT

A wood product includes a composite substrate, such as LVL, that includes treated paper wrapped around and glued to the substrate. The paper seals both the face and the edges of the substrate. As a result, in the case of an LVL substrate, the veneer edges, which are less finished and moisture resistant than the face, are sealed.

### BACKGROUND OF THE INVENTION

The present invention relates to a composite wood product used for certain applications in the residential and commercial building industries, and more particularly as a fascia, trim, siding, or wall covering product for either exterior or interior use.

The present embodiment of the invention is described in the context of exterior wood trim for domestic structures (homes) since this is a common application. Other adaptations could also include exterior siding, doorframes, and stair components. Furthermore, the description refers to Laminated Veneer Lumber, commonly known as LVL, as the basic wood fiber product that becomes an integral component of the final product. Plywood or other wood or non-wood fiber substrates could also be used as an integral component of the final product. In this description, LVL and plywood are each referred to as LVL since both are comprised of wood veneer and adhesive and differ primarily by the orientation of the major grain axis of individual veneers.

Over the years, many types of wood fiber products have been used for exterior trim products. Each of these products has associated advantages and disadvantages. LVL has been used for many years for exterior trim with some success. Over time, technologies have evolved to help improve the appearance of the product. Significant improvements were made when these products began to feature treated paper on a planar surface that is exposed and is usually referred to as the face of the product. Examples of treated paper include medium density overlay (MDO) and kraft linerboard. Treated paper is either resin impregnated or surface treated. To make a product that includes treated paper on its face, the treated paper is permanently bonded to a veneer or panel on its planar surface by simultaneously applying pressure and heat in a hot press.

While traditionally applied treated paper makes the surface very durable and does a good job in masking the natural defects of the underlying substrate—for example, knots, rough grain, open voids—the narrow edges of the rectangular trim product have not received the same protection. Attempts have been made to improve the durability and appearance of these exposed edges by using highly filled and low solids materials (e.g., putties and paints), in addition to special sanding techniques. Historically, the objective has been to fill all open voids and to repair the surfaces of the narrow edges so that they have the appearance of high quality, defect free solid wood. Despite these efforts to modify the edge of the LVL trim product to maintain a desirable appearance over time, consumer expectations have not been fulfilled. Currently, the edges of LVL exterior trim weather or otherwise degrade at a faster rate that the adjacent surface that is covered with treated paper. This differential is a significant disadvantage of LVL exterior trim.

### BRIEF DESCRIPTION OF THE DRAWINGS

FIG. 1 is a perspective view of a single sheet of LVL.

FIG. 2 is a perspective view of the LVL sheet of FIG. 1 joined with finger joints to two other LVL sheets to form an LVL billet.

FIG. 3 is a perspective view of the LVL billet of FIG. 2 being sawn (ripped) down its length to produce preselected product widths.

FIG. 4 is an enlarged, perspective, somewhat schematic view of one of the FIG. 3 cut products being wrapped with treated paper by a profile-wrapping machine.

FIG. 5 is an enlarged perspective view of a portion of the product produced in FIG. 4 depicting a portion of the product face.

FIG. 6 is a view of the other side of the product in FIG. 5.

FIG. 7 is a perspective view of a portion of LVL siding depicting a portion of the faces of two adjacent pieces of siding.

### DETAILED DESCRIPTION

The present embodiment of the invention includes three primary components, namely LVL, treated paper, and adhesive.

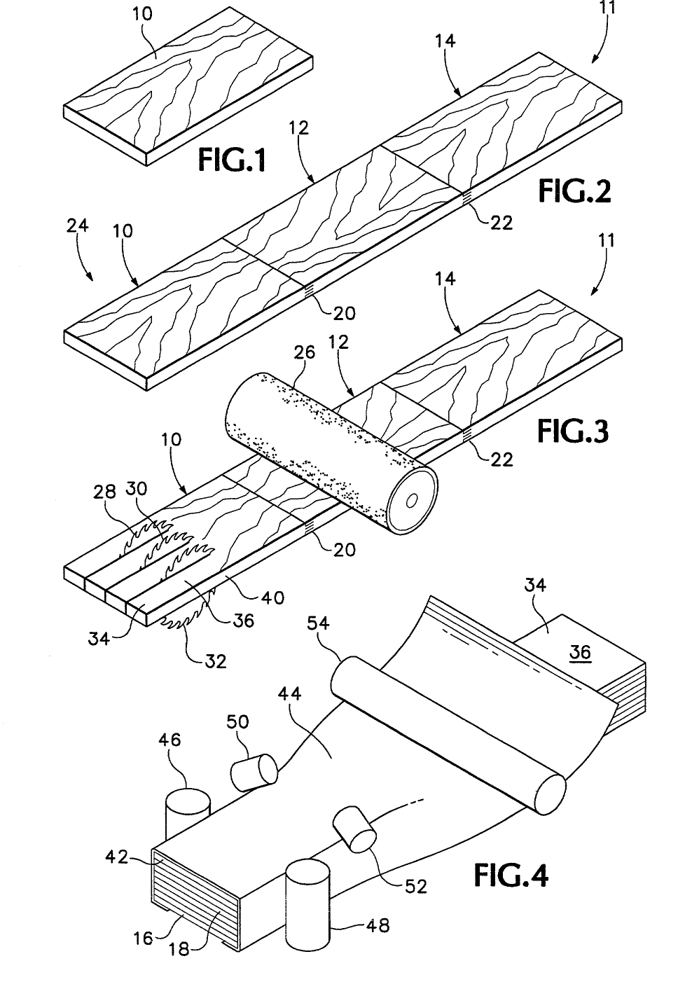

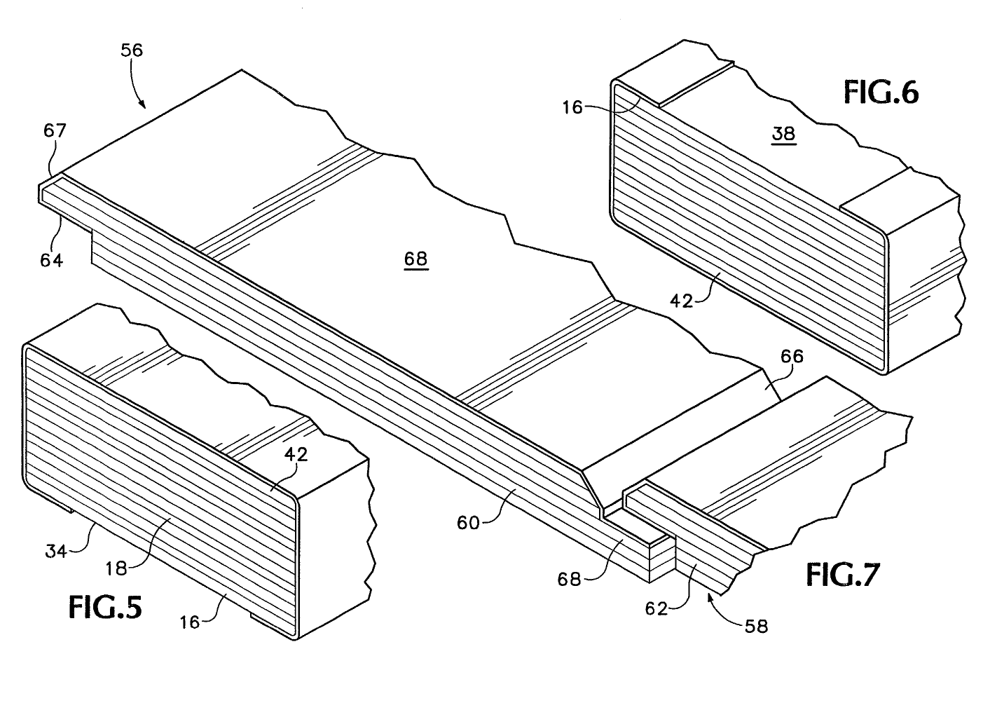

First, indicated generally at 10 in FIG. 1 is an LVL panel. LVL panels typically range between about 0.625 to 2.0 inches in thickness—depending on the number of veneers and the thickness of each—and are 4 feet in width and 8 feet long. LVL panels may be finger jointed or otherwise attached (e.g., by scarfing, which works equally well) to form much longer panels, known as a billet, like billet 11 in FIG. 2. The billet includes LVL panels 12, 14, which are each substantially identical to panel 10. Each LVL panel includes softwood or hardwood veneers, two of which are veneers 16, 18, in FIG. 4, that are glued together under heat and pressure to form the panel. LVL differs from plywood, principally, by the manner in which the major grain axis of each veneer sheet is oriented with respect to the adjacent ply. LVL commonly uses veneers wherein the majority of the sheets are oriented so that the major grain axis runs parallel with the length of the panel. Plywood, on the other hand, typically features veneer sheets that are each oriented 90 degrees to an adjacent ply. LVL panels may be attached—by, e.g., finger joints 20, 22—to form billet 11. Each billet is then sanded, in this case by a sanding roller 26, which eliminates high and low spots, and sawn (ripped) by saw blades 28, 30, 32 to the desired width. An elongate LVL substrate 34 is thereby formed. LVL substrate 34 includes a face 36, visible in FIGS. 3 and 4, a rear surface 38 (in FIG. 6) and a pair of opposing side surfaces, one of which is surface 40 in FIG. 3. Face 36, which is referred to herein as a first exterior surface, and rear surface 38 are each formed on an exterior layer of substrate 34, in this case on outer veneers 42, 16, respectively. The material between face 36 and rear surface 38 is referred to herein as a core. Face 36 is referred to herein as a more finished and moisture resistant surface than the edges, like edge 40, which is referred to herein as a second exterior surface. LVL substrate 34 and the other pieces of billet 11 are cross cut to provide a desired length. Finally, when other than rectangular end products are desired, each piece of LVL is profiled or shaped to the geometry of the final product and is then ready for the application of treated paper. For example, and as will be discussed, FIG. 7 depicts siding that is formed by shaping LVL. Although in the present embodiment LVL is used, fiberboard, preferably medium density fiberboard (MDF), or another substrate could also be used.

Treated paper 44, in FIG. 4, is paper that is impregnated or surface treated with resin. Typical resins include phenolic, isocyanate, melamine, or acrylic. Other resin types may work equally well. Using MDO as an example, conventional MDO is self-adhering and is purchased with a “ready to press” glue line that is on the back of the sheet. Furthermore, conventional MDO is typically purchased as precut (4′×8′, 4″×10′, etc.) sheets. The MDO described herein is a different product in that it does not include a glue line (Dyno Overlay's A-PASS). Another well-suited product is a linerboard product, PB42, which is produced by Pacific Coating and Laminating. The A-PASS or the PB42 treated paper are wound into massive rolls by their respective manufacturers. In accordance with the present embodiment of the inventions, these rolls are slit into desired widths and rewound into smaller rolls for use as described in connection with FIG. 4.

The present embodiment of the invention uses polyurethane adhesive, preferably polyurethane reactive (PUR). Other single and dual component hot melt and liquid adhesives, however, have been tested and work well. In addition, supported pressure sensitive dry films have shown promise in testing. The adhesive can be applied to the treated paper and/or the wood immediately prior to the application of the treated paper to LVL substrate 34. The adhesive is applied between paper 44 and substrate 34 in a manner that will be shortly described.

The introduction and subsequent bonding of paper 44 to the substrate 34 is accomplished by using a profile wrapper, as depicted schematically in FIG. 4. A profile wrapper wraps a material, in this case paper 44, around a specifically shaped substrate—here, substrate 34. In the present embodiment, a profile wrapper manufactured by Duespohl, of Gütersloh, Germany, is used, although other profile wrappers may also be used as well as other laminating equipment. The profile wrapper includes rollers similar to 48, 50, 52, and 54. The profile wrapper is preloaded with precut rolls of paper 44 and the adhesive delivery system is charged with the adhesive.

As substrate 34 is fed into the profile wrapper under control of a guide system (not shown), paper 44 unwinds from a roll under while adhesive (also not shown) is applied to the contact surface(s). Substrate 34 and paper 44 are simultaneously fed through rollers 48, 50, 52, and 54, where the otherwise rigid paper 44 is forced to conform to the shape of substrate 34. The adhesive is applied to the paper 44 or substrate 34, or both, immediately before the paper contacts the substrate. After paper 44 and substrate 34 contact one another, the work piece continues lineally through rollers 48, 50, 52, and 54. The rollers are positioned to force the paper 44 to conform to the shape of substrate 34 while providing adequate pressure as the adhesive cures. A trim saw is present at the end of the machine in order to remove any defective material and to provide a clean cut after wrapping.

It should be noted that a double unwinder is a preferred option on the profile wrapper. This permits paper 44 to be applied as a single sheet, as shown in FIG. 4, or as two separate sheets on surfaces that are not adjacent to one another.

The adhesive provides for a durable, permanent bond between substrate 34 and the paper 44. The end result is a wood product for interior or exterior applications that can be factory primed or painted by the consumer.

Turning now to FIG. 7, two pieces of shaped LVL siding 56, 58 are shown installed on a substantially planar, vertical surface (not shown) of a building. Each piece includes an LVL substrate 60, 62. Substrate 60 includes a notch 64 formed on a rear surface at one side thereof and bevels 66, 67, each of which is referred to herein as a second exterior surface, formed on opposite sides of face. Each of substrates 60, 62 are substantially identical to one another and their manner of manufacture is known in the art. It is also known to apply treated paper to a siding substrate, like substrate 56. In the prior art, however, the paper is applied only to the planar surface between bevels 66, 67. This left veneer edges on the bevel surfaces exposed.

In the present embodiment, treated paper 68 is applied to the face, to the bevel surfaces, and to a planar surface (not visible) defined by veneer 68 along one edge of substrate 56. As a result, all exposed surfaces are sealed with treated paper, including the bevels, which are less finished and moisture resistant compared to the planar surface between the bevels.

In another aspect of the invention, treated paper is sealed to a single planar substrate surface that includes exposed core and/or is less finished and moisture resistant relative to another exposed surface on the substrate.

The embodiments described herein provide a product with a uniform exterior appearance that resists moisture and wear in a uniform manner.

Having described and illustrated the principles of the invention in a preferred embodiment thereof, it should be apparent that the invention can be modified in arrangement and detail without departing from such principles. I claim all modifications and variation coming within the spirit and scope of the following claims.

1. A wood product comprising:
a composite substrate having an exterior layer that presents a first exterior surface;
a core defining the interior of said substrate, said core being exposed on a second exterior surface of said substrate; and
treated paper substantially covering and affixed to at least a portion of said second exterior surface.

2. The wood product of claim 1 wherein said substrate comprises laminated veneer lumber and wherein said first surface comprises a surface on an outer veneer of said substrate and said second surface comprises edges of veneer layers in said laminated veneer lumber.

3. The wood product of claim 1 wherein said substrate comprises fiberboard and wherein said first surface comprises a top surface of said fiberboard and said second surface comprises an edge of said fiberboard.

4. The wood product of claim 1 wherein said substrate is elongate and wherein said paper covers a side edge of said substrate.

5. The wood product of claim 4 wherein said paper covers both a portion of said first exterior surface and said side edge.

6. The wood product of claim 5 wherein said paper covers substantially all of said substrate.

7. The wood product of claim 6 wherein said substrate has a substantially rectangular cross section and where said paper covers at least three sides thereof.

8. The wood product of claim 7 wherein said substrate covers a portion of a fourth side thereof.

9. A wood product comprising:
a laminated veneer lumber substrate having face defined by a surface of a first veneer, a rear surface defined by a surface of a second veneer, and opposing side surfaces defined by veneer edges;
treated paper having a surface that is conformed tightly against at least a portion of one of the side surfaces; and
adhesive disposed between the paper surface and said one side surface.

10. The wood product of claim 9 wherein said paper surface conforms to at least a portion of both said face and said one side surface.

11. The wood product of claim 10 wherein said paper surface substantially conforms to a surface defining a transition between the face and side surface.

12. The wood product of claim 11 wherein said paper surface is conformed tightly against least a portion of each of the side surfaces.

13. The wood product of claim 12 wherein said paper surface is conformed against all of each of the side surfaces.

14. The wood product of claim 13 wherein said paper surface is conformed against at least a portion of the rear surface adjacent the intersection of each of the side surfaces with the rear surface.

15. The wood product of claim 14 wherein the transition between said face and said one side surface is rounded.

16. A wood product comprising:
a composite substrate having first and second exposed surfaces, said first surface being more finished and moisture resistant relative to said second surface;
treated paper covering at least a portion of said second surface; and
adhesive disposed between said treated paper and said portion of said second surface.

17. The wood product of claim 16 wherein said substrate comprises laminated veneer lumber and wherein said first surface comprises a surface on an outer veneer of said substrate and said second surface comprises edges of veneer layers in said laminated veneer lumber.

18. The wood product of claim 16 wherein said substrate comprises fiberboard and wherein said first surface comprises a top surface of said fiberboard and said second surface comprises an edge of said fiberboard.

19. The wood product of claim 16 wherein said substrate is elongate and wherein said paper covers a side edge of said substrate.

20. The wood product of claim 19 wherein said paper covers both a portion of said first surface and said side edge.

21. The wood product of claim 20 wherein said paper covers substantially all of said substrate.

22. The wood product of claim 21 wherein said substrate has a substantially rectangular cross section and where said paper covers at least three sides thereof.

23. The wood product of claim 22 wherein said substrate covers a portion of a fourth side thereof.
